(19) United States
(12) Patent Application Publication
(10) Pub. No.: US 2013/0014678 A1
(43) Pub. Date: Jan. 17, 2013

(54) METHOD AND FACILITY FOR DRYING PASTY MATERIALS, IN PARTICULAR SLUDGE FROM WASTEWATER TREATMENT PLANTS AND GENERATION OF THERMAL ENERGY

(71) Applicants: Peter Knoer, Kreuzlingen (CH); Bruce Stanley, Greifensee (CH)

(72) Inventors: Peter Knoer, Kreuzlingen (CH); Bruce Stanley, Greifensee (CH)

(73) Assignee: Degremont, Paris La Defense (FR)

(21) Appl. No.: 13/519,241

(22) PCT Filed: Dec. 27, 2010
(86) PCT No.: PCT/IB10/56077

§ 371 Date: Oct. 2, 2012

(30) Foreign Application Priority Data
Dec. 30, 2009 (FR) 0906413

(51) Int. Cl. F23G 5/04; C02F 11/12; F23G 5/033; F26B 3/02; F26B 23/02

(52) U.S. Cl. 110/224; 110/346; 34/468; 34/477; 110/223

(57) ABSTRACT

The invention relates to a method for drying pasty materials, in particular sludge from wastewater treatment plants, including a first indirect drying stage (1) supplied with a heat-transfer fluid, which outputs (1a, 1b) pre-dried sludge and water vapour; a step (6) of forming sludge at the outlet of the first stage, and a second stage of drying (7) pre-dried sludge that is heated by means of a heating gas, in particular air, said second stage producing (7b) dried sludge; at least one portion of the dried sludge produced by the second stage is incinerated (23) to produce thermal energy, and at least one portion of said thermal energy is used to heat the heat-transfer fluid of the first drying stage.

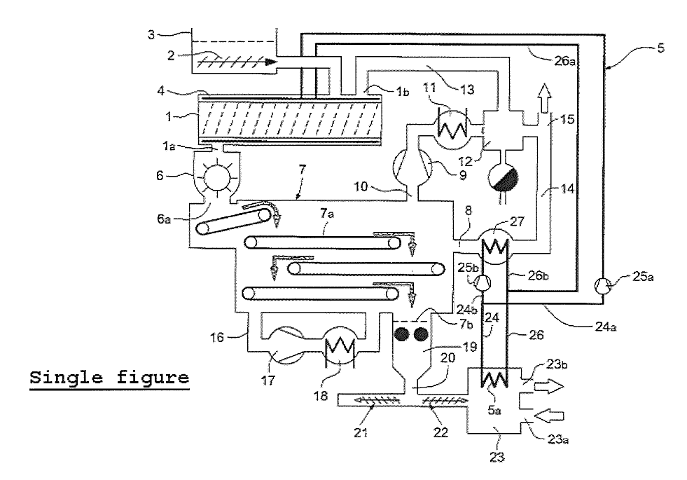

The present invention relates to a method for drying pasty materials, in particular wastewater treatment plant sludge, the energy and thermal efficiency of which is improved.

The thermal technique for drying sludge from urban wastewater treatment plants is known. Various technologies are available for obtaining a finished product whose final dryness is equal to or higher than 85%. The dryness of a sludge can be defined as the ratio of the mass of dried materials (MS) to the total mass of the sludge (MS+water) or: MS/(MS+H₂O).

The main drawback of thermal drying is the high energy expenditure required for drying, incurring high operating costs. Patents EP 0 781 741 B1 and EP 0 889 014 B1 disclose a method for drying pasty products, in particular wastewater treatment plant sludge, aimed at improving the thermal efficiency. According to these patents, the method for drying pasty materials comprises two drying stages, namely:

a first indirect drying stage using a heat transfer fluid, which first stage delivers predried sludge and water vapour at the outlet;

a sludge-forming step for the predried sludge at the outlet of the first stage;

and a second drying stage for the predried sludge, which is heated using a heating gas, in particular air, this second stage producing dried sludge at the outlet.

It is a primary object of the invention to provide a method for reducing the energy required to dry the sludge.

According to the invention, the method for drying pasty materials, in particular wastewater treatment plant sludge, comprises two drying stages, namely:

a first indirect drying stage fed with a heat transfer fluid, which delivers predried sludge and water vapour at the outlet;

a sludge-forming step at the outlet of the first stage,

and a second drying stage for the predried sludge, which is heated using a heating gas, in particular air, this second stage producing dried sludge at the outlet;

and is characterized in that:

the predried sludge exiting the first drying stage is introduced into a sludge extruder able to form bands of sludge, or the like, which fall into a second dryer,

the dried sludge leaving the second drying stage is subjected to mechanical action to produce aggregates and at least part of the aggregates is incinerated to produce heat energy;

and at least part of this heat energy is used to heat the heat transfer fluid of the first drying stage.

Preferably, the water vapour leaving the first drying stage is sent to a condenser to heat therein the heating gas of the second drying stage.

Advantageously, the heat transfer fluid for the heating of the first drying stage flows in a closed loop and is heated by the incineration of the sludge. The heat transfer fluid may consist of oil or water vapour.

The closed loop may comprise a bypass with heater between the heat transfer fluid of the loop and the heating gas which enters the second drying stage.

The heat energy supplied by the incineration of the sludge may be supplemented by an external energy from one or more energy sources selected from gas, oil, biogas, steam, flue gases.

A fraction of gas may be extracted between the first drying stage and the second drying stage and is sent to the air inlet of the heating system for incineration.

Advantageously, the incineration of the sludge aggregates is carried out in an incinerator of the group from comprising fluidized bed incinerators, cyclone incinerators, mobile grid incinerators, fixed grid incinerators, multistage grid incinerators, rotary incinerators or other similar incinerators.

Additional heat may be recovered from the flue gases produced by the incineration.

The invention also relates to an installation for drying pasty materials, in particular wastewater treatment plant sludge, for implementing the method defined above, which installation comprises:

a first indirect predrying unit for a heat transfer fluid, which unit delivers at the outlet predried sludge and water vapour which is sent to a condenser to heat therein a heating gas;

a sludge forming device at the outlet of the first drying unit;

and a second drying unit for drying the predried sludge, which is heated using a heating gas, in particular air;

and which is characterized in that it comprises:

a unit for incinerating at least part of the sludge leaving the second drying unit to produce heat energy;

and heat exchange means for transferring at least part of this heat energy produced to the heat transfer fluid of the first drying stage.

Preferably, the installation comprises, at the outlet of the second drying unit, a reducer for exerting a mechanical action on the dried sludge and for producing it in the form of finer aggregates.

The heat exchange means advantageously comprise a closed loop which comprises a bypass with heater between the heat transfer fluid of the loop and the heating gas which enters the second drying stage.

The invention, apart from the arrangements disclosed above, consists of a number of other arrangements discussed in greater detail below with regard to an exemplary embodiment described with reference to the appended figure, but which is not limiting.

The single figure of this drawing is a schematic of a drying installation implementing the inventive method.

Referring to the drawing, it shows an installation for drying pasty materials, in particular wastewater treatment plant sludge, which comprises a first dryer 1, or predrying unit, of the indirect type. The sludge feed of the dryer 1 is provided by a pump 2, from a silo 3 containing the sludge to be dried. The heat transfer fluid flows in lines 4 connected to a loop 5 which is described below. The heat transfer fluid of the loop 5 preferably consists of oil or water vapour.

Indirect dryer means an apparatus in which a heat transfer fluid used for drying the sludge flows in lines with heat exchange between the heat transfer fluid and the sludge to be dried, without being in direct contact with this sludge. The dryer 1 may be of the thin film, disc or vane type.

The dryer 1 delivers predried sludge at an outlet 1a and, at another outlet 1b, water vapour. The predried sludge is introduced into a sludge extruder 6 for forming bands of sludge or similar, which fall through the outlet 6a of the extruder, into a second dryer 7, for example of the belt type 7a as shown in the drawing. The dryer 7 is of the direct type, that is, the sludge flowing on the belts 7a is in direct contact with a heating gas, in particular hot air, introduced via an inlet 8.

The sludge leaving the dryer 1, which is still in the plastic phase, is extruded through a perforated plate comprising holes having a selected diameter (sludge extruders) in order to produce elements having uniform and predefined size.

The gas from the dryer 7 is extracted using a fan 9 via an outlet 10 to pass through, if applicable, a cooling unit 11, followed by a condenser 12. The gas therein is heated by condensation of the water vapour which leaves the first dryer 1 via the orifice 1b and which is sent via the duct 13 to the condenser 12. At the outlet of the condenser 12, the heated gas is returned, at least partly, via a duct 14, to the inlet 8. Optionally, another part of the gas is removed at the exhaust via an outlet 15. The latent heat of vaporization of the water is recovered in the condenser 12.

A bypass 16 may be provided, equipped with a fan 17 to withdraw gas from the dryer 7 and to reintroduce it into this dryer after having made it pass through a cooling unit 18.

The dryer 7 comprises, at the dried sludge outlet 7b, a reducer 19, or grinder, for applying mechanical action to the dried sludge to deliver it, at the outlet 20, in the form of aggregates of smaller size than at the outlet of the first dryer 1. The dryness of the dried sludge leaving the dryer 7 may be as high as 95%.

The aggregates leaving the reducer 19 are partly removed via a feed device 21, in particular a screw device, to a storage silo and, for another part, by a feed device 22, in particular a screw device, to an incinerator 23, constituting a heating unit, with an air inlet 23a and a flue gas outlet 23b.

The loop 5 of the heat transfer fluid of the first drying stage 1 comprises a heat exchanger 5a located in the incinerator 23, for heating the heat transfer fluid from the heat energy produced by the incineration of the dried sludge aggregates.

The outlet branch 24 of the heat exchanger 5a, for the heated heat transfer fluid, is divided into two branches 24a, 24b, each equipped with a pump 25a, 25b when the fluid consists of oil, or another regulating means when the fluid consists of water vapour.

The branch 24a conveys the heated heat transfer fluid to the lines 4 of the dryer 1. The return of the heat transfer fluid to the incinerator 23 is provided by a line 26a which joins a return branch 26 of the heat exchanger 5a.

The branch 24b sends the heat transfer fluid to a heater 27, for heating gas, which then enters the second dyer 7, by the heat transfer fluid which returns to the branch 26 via a line 26b.

The heat energy supplied to the heat transfer fluid of the loop 5 by incineration of the aggregates may be supplemented by an external energy from one or more energy sources selected, for example, from gas, oil, biogas, water vapour, flue gases, etc.

The energy generation provided by the incineration of the dried sludge and its direct use in the installation, in the first dryer 1 with recovery of the latent heat of vaporization, serves to reduce the external energy requirements and to substantially improve the thermal yield of the sludge drying method.

The dried aggregate produced from the wastewater treatment plant sludge has a high heating value which depends on the ratio of the organic matter to the total quantity of dry solid, on the properties of the sludge itself and on the moisture content. This property means that the dried sludge constitutes a viable source of heat energy for the abovementioned method.

The sludge feed may be manual or automatic. The quantity incinerated depends on the requirements and may be supplemented with external energy sources such as but not limited to: gas, oil, biogas, solid fuel, etc. Any treated sludge which is not required by the heating system is removed in any prescribed manner.

The exhaust gases leaving the installation between the first predrying unit and the second drying unit, or issuing from any part of the installation, may be sent to the air inlet 23a of the heating system 23 where they are mixed with the main air stream for the heating system. This arrangement serves to increase the inlet air temperature and to deodorize the exhaust gas stream.

The heating system consisting of the incinerator 23 may be used with or without a flue gas treatment system.

The heating system may incorporate a unit for recovering additional heat from the flue gases.

The heat generated by the incineration of the aggregates may be used to raise the temperature of any means selected such as, but not limited to: oil and air, or to generate steam, to heat the equipment of the installation.

The equipment of the installation may be provided in an ATEX environment, or in a non-ATEX environment.

Control of the method may be automatic or manual or a combination of both. The method may be continuous or non-continuous, or a combination of both.

The method of the invention may be applied to a method and/or to an installation according to EP 0 781 741 or EP 0 889 014.

The method of the invention can be applied to drying processes and to installations other than those described according to EP 0 781 741 or EP 0 889 014.

1-11. (canceled)

12. A method for drying pasty materials, in particular wastewater treatment plant sludge, comprising:
drying a heat transfer fluid in a first indirect drying stage (1), which delivers predried sludge and water vapour at the outlet (1a, 1b);
a sludge-forming step (6) at the outlet of the first drying stage, and
drying the predried sludge in a second drying stage (7), which is heated using a heating gas, in particular air, this second drying stage producing dried sludge at the outlet (7b);
wherein:
the predried sludge exiting the first drying stage (1) is introduced into a sludge extruder (6) able to form bands of sludge, or the like, which fall into a second dryer (7),
the dried sludge leaving the second drying stage is subjected to mechanical action (19) to produce aggregates and at least part of the aggregates is incinerated (23) to produce heat energy; and
at least part of this heat energy is used to heat the heat transfer fluid of the first drying stage.

13. A method according to claim 12, wherein the water vapour leaving (1b) the first drying stage is sent to a condenser (12) to heat therein the heating gas of the second drying stage (7).

14. A method according to claim 12, wherein the heat transfer fluid consists of oil or water vapour.

15. A method according to claim 12, wherein the heat transfer fluid for the heating of the first drying stage (1) flows in a closed loop (5) and is heated by the incineration of the sludge.

16. A method according to claim 15, wherein the closed loop (5) comprises a bypass (24a, 24b) with heater (27) between the heat transfer fluid of the loop (5) and the heating gas which enters the second drying stage (7).

17. A method according to claim 12, wherein the heat energy supplied by the incineration of the sludge is supplemented by an external energy from one or more energy sources selected from gas, oil, biogas, steam, flue gases.

18. A method according to claim 12, wherein a fraction of gas is extracted between the first drying stage and the second drying stage and is sent to the air inlet (23a) of the heating system for incineration.

19. A method according to claim 12, wherein incineration of the sludge is carried out in an incinerator of the group comprising fluidized bed incinerators, cyclone incinerators, mobile grid incinerators, fixed grid incinerators, multistage grid incinerators, rotary incinerators.

20. A method according to claim 12, wherein additional heat is recovered from the flue gases produced by the incineration.

21. An installation for drying pasty materials, in particular wastewater treatment plant sludge, the installation comprising:
a first indirect predrying unit (1) for predrying with the aid of a heat transfer fluid, which unit delivers at the outlet (1a, 1b) predried sludge and water vapour which is sent to a condenser (12) to heat therein a heating gas;
a sludge-forming device (6) at the outlet of the first drying unit (1);
and a second drying unit (7) for drying the predried sludge, which is heated using a heating gas, in particular air; and further comprising:
at the outlet of the first predrying unit (1) an extruder (6) of the predried sludge which is able to form bands of sludge, or the like, which fall into a second dryer (7),
at the outlet (7b) of the second drying unit, a reducer (19) to exert mechanical action on the dried sludge and produce it in the form of aggregates;
a unit (23) for incinerating at least part of the aggregates leaving the second drying unit to produce heat energy; and
heat exchange means (5, 5a) for transferring at least part of this heat energy produced to the heat transfer fluid of the first drying stage (1).

22. The installation according to claim 21, wherein the heat exchange means comprise a closed loop (5) which comprises a bypass (24b, 26b) with heater (27) between the heat transfer fluid of the loop and the heating gas which enters the second drying stage (7).
